(19) United States
(12) Patent Application Publication
(10) Pub. No.: US 2026/0047529 A1
(43) Pub. Date: Feb. 19, 2026

(54) Hay Bale RFID Reader Antenna Configuration

(71) Applicant: AGCO Corporation, Duluth, GA (US)

(72) Inventors: Eric John Herbers, Hesston, KS (US); Grant Lewis Good, Moundridge, KS (US)

(21) Appl. No.: 19/101,702

(22) PCT Filed: Jul. 11, 2023
(86) PCT No.: PCT/IB2023/057112

§ 371 Date: Feb. 6, 2025

Related U.S. Application Data
(60) Provisional application No. 63/374,013, filed on Aug. 31, 2022.

(51) Int. Cl. A01D 87/12; H01Q 1/22

(52) U.S. Cl. CPC A01D 87/122; H01Q 1/2208

(57) ABSTRACT

A bale handling mechanism includes a structural frame having bale spears extending forwardly therefrom configured to engage a bale so that the bale is received substantially adjacent a bale-facing plane that is defined by the points on the bale handling mechanism that contact the closest vertical surface of a bale that is fully received on the bale handling mechanism. At least one antenna mount is affixed to the frame having a mount axis that is parallel with the bale-facing plane. An antenna pair is attached to the antenna mount that interacts with an identification tag on the bale. The antenna pair includes first and second antennae each having an antenna axis that is perpendicular to a beam axis of the antenna, wherein the first and second antennae are oriented such that the antenna axis of the first antenna is non-parallel with the antenna axis of the second antenna.

### BACKGROUND

### Field of Invention

The present disclosure is generally related to agricultural bale moving equipment and, more particularly to a method and assembly for reading bale identification tags on bales of agricultural crop material.

### Description of Related Art

Harvested agricultural crop material is often formed into compressed bales by baling machines so that the crop material may be more easily transported, stored and put into use. A knotter system is configured to loop a binding material around the finished bale so that the bale maintains its compressed shape. As the baled crop material is formed in the baler, certain parameters or attributes of the crop material or bale such as moisture, bale weight, bale length, variety, location, feed value, mass flow, flake count, time of day, etc., may be measured or determined by the baler using known sensors and techniques.

It is known to attach a bale identification tag to the bale, for identification purposes. FIG. 4 illustrates an example bale 402 with a bale identification tag 404 being attached to the bale with the binding material. Typically, the bale identification tag is a passive radio-frequency identification (RFID) tag used to electronically store information and collect energy from a nearby RFID reader's interrogating radio waves. A bale identification assembly and identification tags may be as those that are as described in commonly assigned U.S. Pat. No. 10,303,997 entitled Bale Identification Assembly for Binding and Identification Tag to a Bale of Agricultural Crop Material, which is incorporated herein by reference.

After the bales are formed, they are loaded onto transport vehicles using a bale moving apparatus. If the identification tags 404 are to be read with an antenna and a reader as the bales are handled or moved using the bale moving apparatus, there can be an inherent problem of being able to read tags which could be located anywhere across the entire length of the bale 402. Antenna beam pattern are typically narrow enough that some tags fall outside of the readable zone, even if multiple antennas are utilized.

### BRIEF SUMMARY

In one aspect, the invention is directed to a bale handling mechanism for lifting and moving a bale, the bale handling mechanism including a structural frame, wherein the frame has a plurality of bale spears extending forwardly therefrom configured to engage and penetrate a bale so that the bale is received on the bale handling mechanism substantially adjacent a bale-facing plane that is defined by the points on the bale handling mechanism that contact the closest vertical surface of a bale that is fully received on the bale handling mechanism. The bale handling mechanism has at least one antenna mount affixed to the frame, the antenna mount having a mount axis that is parallel with the bale-facing plane formed by the frame. An antenna pair is attached to the antenna mount configured to interact with an identification tag on a bale carried on the bale handling mechanism. The antenna pair includes a first antenna and a second antenna, each of the first antenna and the second antenna having an antenna axis that is perpendicular to a beam axis of the antenna, wherein the first antenna and second antenna are oriented such that the antenna axis of the first antenna is non-parallel with the antenna axis of the second antenna so that each of the first antenna and second antenna has an antenna axis that is angled relative the mount axis such that together the antenna axis and mount axis form an angle, wherein the first antenna and second antenna of the antenna pair are oriented on the bale handling mechanism in a configuration which is non-parallel to the bale-facing plane of the frame and thus the vertical face of the bale that is being handled on the bale handling mechanism.

These and other features and advantages of this invention are described in, or are apparent from, the following detailed description of various exemplary embodiments of the systems and methods according to this invention.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a perspective view of a bale handling mechanism in accordance with one embodiment;

FIG. 2 illustrates a front view of the handling mechanism of FIG. 1;

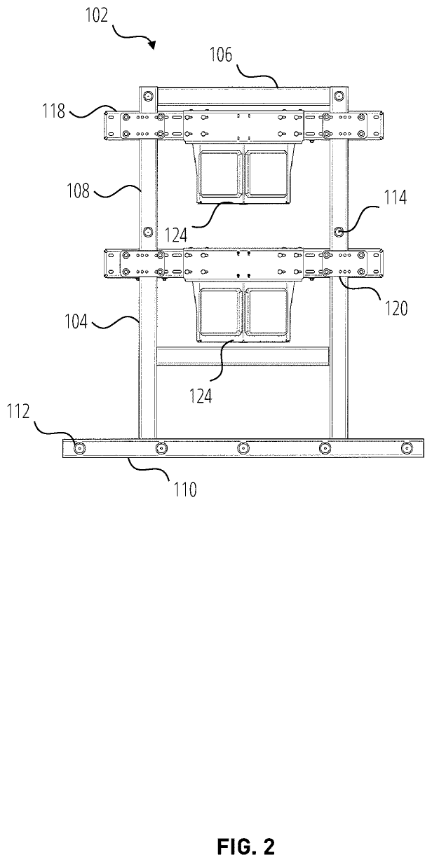

FIG. 3 illustrates a top view of the bale handling mechanism of FIG. 1;

FIG. 4 illustrates a prior art depiction of a bale of crop material being wrapped with a binding material having a bale identification tag.

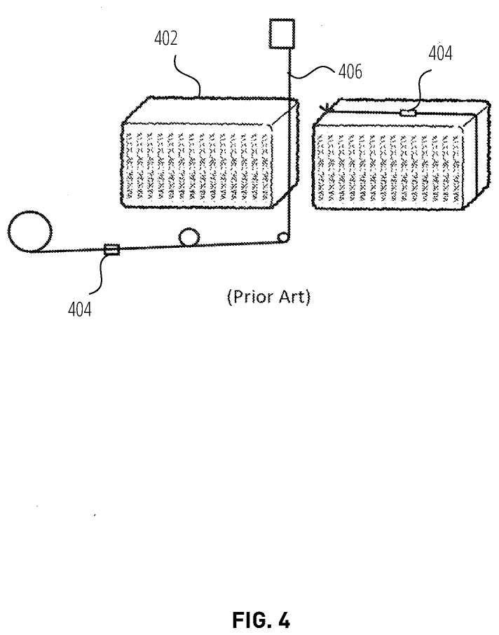

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

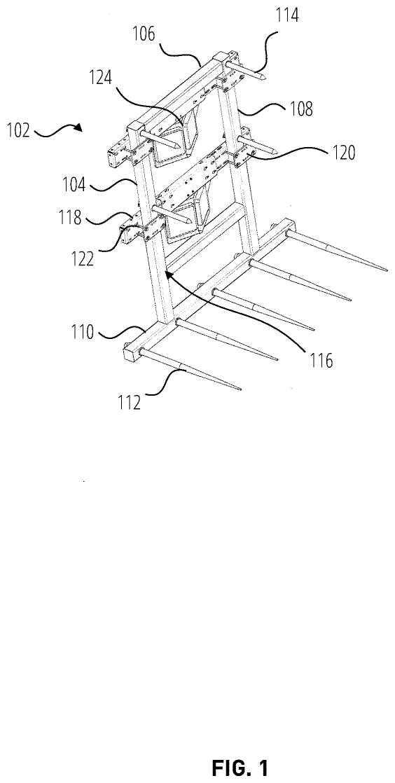

Referring now to the Figures, FIG. 1 shows a bale handling mechanism 102 such as one that is attached to a tractor, skid steer, or other loading vehicle (not shown) having hydraulic lifting arms so that the bale handling mechanism 102 can be used to pick up and move a bale of compressed agricultural material. The loading vehicle uses the bale handling mechanism 102 to load the bale onto a truck, trailer or other suitable hauling vehicle or to place the bale in a storage location. As the bale handling mechanism 102 can be used on any suitable loading vehicle without departing from the scope of the invention, further description of loading vehicles need not be contained herein.

The bale handling mechanism 102 includes a structural frame 104. In one embodiment, the frame 104 has horizontal cross members 106 coupled in coplanar, parallel relationship with a pair of vertical side members 108, which are mounted to ends of the cross members 106. Working in conjunction with the cross members 106 is a bottom member 110 mounted between the side members 108. The bottom member 110 has a plurality of bale spears 112 each having an inboard end coupled to the bottom member 110 and extending forwardly therefrom. Such bale spears 112 preferably reside in perpendicular relationship with the horizontally oriented cross members 106 and the vertically oriented side members 108. In the illustrated embodiment, each side member 108 has at least one bale spike 114 extending forwardly therefrom. Further, each bale spear 112 and bale spike 114 ideally has a sharpened end. The bale spears 112 and bale spikes 114 engage and penetrate the bale so that the bale is received on the bale handling mechanism 102 substantially adjacent a bale-facing plane 116 that is defined by the points on the bale handling mechanism 102 that contact the closest vertical surface of a bale that is fully received on the bale handling mechanism 102.

Accordingly, the bale handling mechanism 102 can lift and move the bale as desired. While the illustrated embodiment of the frame 104 shows the cross members 106 and the side members 108 in horizontal and vertical orientations, one skilled in the art will understand that the components of the frame 104 may be arranged in different orientations without departing from the scope of the invention.

The frame 104 further includes at least one antenna mount 118 affixed thereto. In the illustrated embodiment, the antenna mount 118 extends between the side members 108 such that it is generally parallel with the cross members 106 and attaches to the side members 108 with a bracket 120 and suitable bolts 122.

Also, the illustrated embodiment shows the cross member 106 and side members 108 arranged such that a forward or bale-facing surface of each member lies in the bale-facing plane 116 such that the bale contacts the forward surfaces of the side members 108 and/or cross members 106. However, one skilled in the art will understand that the cross members 106 and side members 108 may be oriented such that the forward surface of one or more of the members may be slightly offset from the others such that one or more of the forward surfaces may not contact the bale when the bale is received against the forward surfaces of the remaining members of the frame 104. Additionally, as the bale is formed of compressible agricultural material, it is acceptable to have some irregularities in the bale-facing plane 116, such as that caused by the bracket 120 attaching the antenna mount 118 to the frame 104.

The antenna mount 118 is oriented such that a mount axis 302 is parallel with the bale-facing plane 116 formed by the frame 104. Attached to the antenna mount 118 is an antenna pair 124 configured to interact with an identification tag on a bale carried on the bale handling mechanism 102. In one embodiment, the identification tag may be as described in commonly assigned U.S. Pat. No. 10,303,997. However, one skilled in the art will understand that any suitable RFID or other tag that can be affixed to a bale and is capable of interacting with an antenna and a reader may be used without departing from the scope of the invention. Accordingly, identification tags need not be further described herein. The antenna pair 124 is desirably located near a horizontal center of the bale handling mechanism 102.

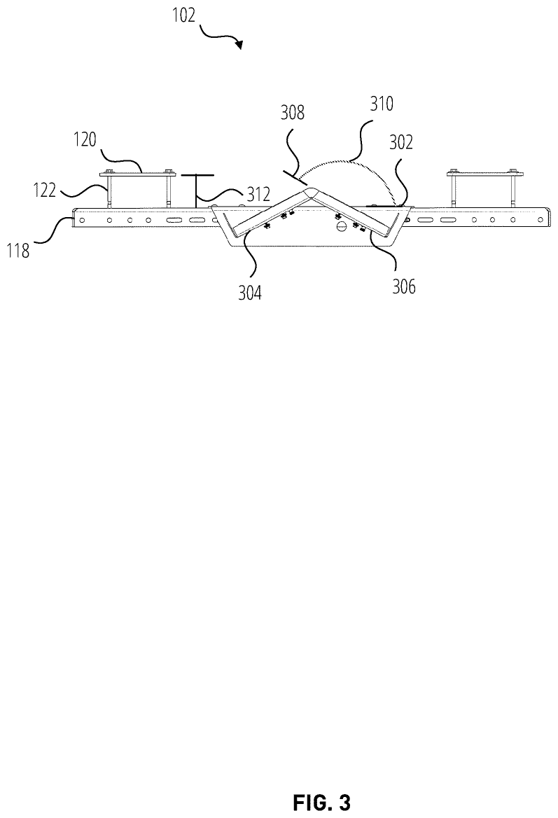

Each antenna pair 124 includes a first antenna 304 and a second antenna 306. In one embodiment, each of the first antenna 304 and the second antenna 306 are directional antennas designed to radiate most of its power in a main lobe directed away from the antenna. As is known in the art, a beam axis or axis of maximum radiation passes through the center of the main lobe. The antenna radiates other minor or side lobes. Any suitable antenna may be used for the first antenna 304 and second antenna 306. As best seen in FIG. 3, each of the first antenna 304 and the second antenna 306 has an antenna axis 308 that is perpendicular to the beam axis of the antenna. The first antenna 304 and second antenna 306 are oriented such that the antenna axis 308 of the first antenna 304 is non-parallel with the antenna axis 308 of the second antenna 306. In one embodiment illustrated in FIG. 3, the non-parallel configuration is an outward facing “V” shape. Thus, each of the first antenna 304 and second antenna 306 has an antenna axis 308 that is angled relative the mount axis 302 such that together the antenna axis 308 and mount axis 302 form an angle 310 as seen in FIG. 3.

Accordingly, the first antenna 304 and second antenna 306 of the antenna pair 124 are oriented on the bale handling mechanism 102 in a configuration which is non-parallel to the bale-facing plane 116 of the frame 104 and thus the vertical face of the bale that is being handled on the bale handling mechanism 102. It has been found that this orientation improves the read-reliability for identification tags located in various unknown positions across the top of the bale. In the illustrated embodiment, there are two antenna pairs 124 vertically spaced on the bale handling mechanism 102. However, one skilled in the art will understand that there could be only a single antenna pair, or that there may be more than two antenna pairs on the bale handling mechanism 102 without departing from the scope of the invention.

The first antenna 304 and second antenna 306 of the antenna pair 124 are wired together using a splitter so they behave and are utilized by an associated RFID reader (not shown) as one larger antenna. Desirably, the antenna pair 124 is used in a horizontal linear polarization arrangement. It is believed that by arranging the first antenna 306 and second antenna 306 into the antenna pair 124 like this, the beam width ends is wider, approximately double, the beam width of what you'd see with a single antenna. Desirably, the antenna pair 122 forms a thin fan shaped beam pattern instead of a cone shaped beam pattern. This allows the antenna pair 124 to have better RF gain across the width of the bale without dissipating or wasting energy in a taller beam width than needed.

As perhaps best seen in FIG. 3, in the illustrated embodiment the antenna mount 118 abuts a rear surface of the side members 108 such that the antenna pair 124 resides in a cavity 312 between the side members 108 and/or the cross members 106 and behind the forward surfaces of the side members 108 and/or cross members 106 to minimize contact of the antenna pair 124 with the bale when the bale is fully engaged by the bale handling mechanism 102 to minimize risk of damaging the antenna pair 124.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A bale handling mechanism for lifting and moving a bale, the bale handling mechanism comprising:
a structural frame, wherein the frame has a plurality of bale spears extending forwardly therefrom configured to engage and penetrate a bale so that the bale is received on the bale handling mechanism substantially adjacent a bale-facing plane that is defined by the points on the bale handling mechanism that contact the closest vertical surface of a bale that is fully received on the bale handling mechanism;
at least one antenna mount affixed to the frame, the antenna mount having a mount axis that is parallel with the bale-facing plane formed by the frame; and
an antenna pair attached to the antenna mount, the antenna pair configured to interact with an identification tag on a bale carried on the bale handling mechanism, the antenna pair includes a first antenna and a second antenna, each of the first antenna and the second antenna having an antenna axis that is perpendicular to a beam axis of the antenna, wherein the first antenna and second antenna are oriented such that the antenna axis of the first antenna is non-parallel with the antenna axis of the second antenna so that each of the first antenna and second antenna has an antenna axis that is angled relative the mount axis such that together the antenna axis and mount axis form an angle, wherein the first antenna and second antenna of the antenna pair are oriented on the bale handling mechanism in a configuration which is non-parallel to the bale-facing plane of the frame and thus the vertical face of the bale that is being handled on the bale handling mechanism.

2. The bale handling mechanism of claim 1 wherein the non-parallel configuration is an outward facing “V” shape.

3. The bale handling mechanism of claim 2 wherein the frame has horizontal cross members coupled in coplanar, parallel relationship with a pair of vertical side members, which are mounted to ends of the cross members and a bottom member mounted between the side members.

4. The bale handling mechanism of claim 3 wherein the at least one antenna mount extends between the side members such that it is parallel with the cross members and attaches to the side members with a bracket and suitable bolts.

5. The bale handling mechanism of claim 4 wherein the antenna mount abuts a rear surface of the side members such that the antenna pair resides in a cavity between the side members and the cross members and behind the forward surfaces of the side members and cross members to minimize contact of the antenna pair with the bale when the bale is fully engaged by the bale handling mechanism.

6. The bale handling mechanism of claim 1 wherein there are two antenna pairs vertically spaced on the bale handling mechanism. However, one skilled in the art will understand that there could be only a single antenna pair, or that there may be more than two antenna pairs on the bale handling mechanism without departing from the scope of the invention.

7. The bale handling mechanism of claim 1 wherein the first antenna and second antenna of the antenna pair are wired together using a splitter so they behave and are utilized by an associated RFID reader as one larger antenna.

8. The bale handling mechanism of claim 1 wherein each of the first antenna and the second antenna are directional antennas designed to radiate most of its power in a main lobe directed away from the antenna such that a beam axis or axis of maximum radiation passes through the center of the main lobe.
